(19) United States
(12) Patent Application Publication
(10) Pub. No.: US 2008/0050199 A1
(43) Pub. Date: Feb. 28, 2008

(54) Fix bolt-unfastening preventing structure

(75) Inventor: Jungsik Park, Wonju-si (KR)

Correspondence Address: LAHIVE & COCKFIELD, LLP, ONE POST OFFICE SQUARE, BOSTON, MA, 02109-2127, US

(73) Assignee: Mando Corporation, Pyeongtaek-si (KR)

(21) Appl. No.: 11/893,860

(22) Filed: Aug. 17, 2007

(30) Foreign Application Priority Data
Aug. 22, 2006 (KR) KR2006-79551

(51) Int. Cl. F16B 35/04

(52) U.S. Cl. 411/402

(57) ABSTRACT

Disclosed is a fix bolt-unfastening preventing structure. The fix bolt unfastening structure includes a fix bolt including a head designed to be fitted to a fastener tool, and a body integrally formed with the head, wherein the body has a threaded portion on a circumferential surface thereof and a press fit portion formed at one end thereof; and a fix member having a press fit hole into which the press fit portion is to be press-fitted. According to the present invention as described above, there is an advantage that in order to prevent unfastening of the fix bolt which is used for connection of various components, the fix bolt is threaded engaged with the fix member while the press fit portion formed at the end of the male screw thread of the fix bolt is press-fitted into the press fit hole formed at an end of the fix member, which enables the reduction of parts and cost and the prevention of unfastening of the fix bolt.

### RELATED APPLICATION

This application claims priority to Korean patent application No. KR2006-79551 filed on Aug. 22, 2006, the content of which is incorporated by reference.

### FIELD OF THE INVENTION

The present invention relates to a fix bolt-unfastening preventing structure. More particularly, the present invention relates to a fix bolt-unfastening preventing structure which includes a fix member having a female threaded portion and a press fit hole formed at an end of the female threaded portion, and a fix bolt having a male threaded portion and a press fit portion formed at an end of the male threaded portion, wherein the press fit portion of the bolt is press-fitted into the press fit hole of the fix member, enabling prevention of unfastening of the fix bolt while reducing parts and cost.

### BACKGROUND OF THE INVENTION

As generally known in the art, there are various types of fix bolts, such as countersunk head bolts, round-head bolts, hexagon head bolts, headless bolts, etc. The fix bolts including such various types of bolts are generally used to connect two components to each other and to support or to press and connect different components with each other while being threaded engaged with a female screw.

FIG. 1 is a sectional view of the principal part of a conventional fix bolt in a fastened state. As shown in the drawing, a fix bolt 110 having a male threaded portion 120 and a fix member 130 having a female threaded portion 140 are manufactured in such a manner to permit gaps 150 to be formed between the male threaded portion 120 and the female threaded portion 140 when being threaded engaged with each other, thereby facilitating the insertion of the male threaded portion 120 of the fix bolt 110 into the female threaded portion 140 of the fix member 130.

Meanwhile, when the fix bolt 110 is threaded engaged with the fix member 130, the male threaded portion formed spirally on the fix bolt 110 and the female threaded portion 140 of the fix member 130 are in contact with each other at one side surfaces of the threads, whereas the gaps still remain between other side surfaces of the threads where the male threaded portion and the female threaded portion are not in contact with each other.

The fix bolt 110 and the fix member 130 continue to be coupled together by coupling force given by the frictional resistance between their contact surfaces while forming the gaps as described above. At this time, if either external force acting in an axis of the fix bolt 110 is greater than the frictional resistance between the contact surfaces or external force although it is smaller than the frictional resistance acting continuously, the unfastening of the fix bolt 110 from the fix member 130 arises. Namely, by minute vibrations or strong vibrations generated by the external force acting in the axis of the fix bolt, the fix bolt is minutely moved to thereby escape from a fastened position and to be unfastened.

Accordingly, in order to prevent the unfastening of the fix bolt, there have been employed various means or methods, such as a spring washer which continuously provides elastic force to the threaded portion, a double nut manner wherein a nut is threaded engaged with the fix bolt by using the extension of the fix bolt 110 and the constriction of the nut and then another nut is further fastened to the fix bolt, a lock nut which has a caulked portion or molded portion formed at an end of a threaded portion so that the caulked portion or molded portion forms a forced threaded portion when threaded engaged with the fix bolt so as to provide the prevention of loosening, and an adhesive for attaching the contact portions of the fix bolt and a nut or resin, such as a liquid for the prevention of screw unfastening, which is applied to the contact portions.

However, the above mentioned means or methods have difficulties in obtaining a constant load and maintaining unfastening force after the fix bolt is unfastened at a certain angle. Also, there has been a problem in that the above mentioned means and methods cause increased parts, and thus result in increased costs.

There has also been a problem in that since an additional applicator is needed in order to apply the adhesive and the liquid for the prevention of screw unfastening, and application work and attachment work should be additionally carried out, the total working time is lengthened.

FIG. 2 is a view of a conventional fix bolt having an unfastening preventing structure. As shown in the drawing, the convention fix bolt 110 having an unfastening preventing structure includes unfastening preventing protrusions 210 which outwardly protrude from screw threads formed in a spiral shape on a male threaded portion 120 and are in the shape of a triangle.

The unfastening preventing protrusions 210 having a triangle structure each protrusion outwardly from an outer circumference end of every screw thread, and at least one unfastening preventing protrusion 210 is formed on every screw thread. The length of the protrusions is commonly designed to be greater than each gap formed between each male thread of a male threaded portion 120 and the bottom of thread of a female threaded portion 140.

Each of the unfastening preventing protrusions 210 has an inclined portion 214 at a side toward a direction in which the fix bolt 110 is threaded engaged with reference to a vertex of the triangle structure and an end portion 216 at the opposite side of the inclined portion 214, in which the end portion 216 prevents the fix bolt 110 from unfastening after being threaded engaged.

Here, the inclined portion 214 is designed to protrude in the shape of a gentle inclination from an end of the male threaded portion and continuously connected with the end of the male threaded portion, so that the unfastening preventing protrusions 210 are threaded engaged with the female threaded portion 140 when the fix bolt 110 is threaded engaged.

Each of the end portions 216 protrude from the end of the screw thread of the male threaded portion 120 in a vertical direction relative to the screw thread and is formed nearly perpendicular to the screw thread, so that after the fix bolt 110 is threaded engaged, the vertexes are stuck on the bottom of thread, and at the same time, the end portions 216 are in line contact with a thread surface of the female threaded portion, thereby preventing the fix bolt 110 from unfastening.

However, in the conventional fix bolt shown in FIG. 2, there has been a problem in that the conventional fix bolt is not suitable for mass production, since the unfastening preventing protrusions 210, in addition to the threads which require precision finishing, should be even more precisely manufactured, and productivity is thus reduced due to the increased working time. Also, since the unfastening preventing protrusions 210 injure the bottom of the threads of the female threaded portion while the fix bolt 110 with the unfastening preventing protrusions 210 is threaded engaged with the female threaded portion, the male threaded portion 120 of the fix bolt 110 is damaged accordingly.

### SUMMARY OF THE INVENTION

Accordingly, the present invention has been made to solve the above-mentioned problems occurring in the prior art, and the present invention provides a fix bolt-unfastening preventing structure which is used for connection of various components, wherein the fix bolt is threaded engaged with the fix member while the press fit portion formed at the end of the male screw thread of the fix bolt is press-fitted into the press fit hole formed at an end of the fix member, thereby enabling the reduction of parts and cost and the prevention of unfastening of the fix bolt.

Also, the present invention provides a fix bolt-unfastening preventing structure wherein the press fit portion is formed at the threaded portion of the fix bolt, thereby reducing the working time for precision machining while increasing productivity.

In accordance with an aspect of the present invention, there is provided a fix bolt-unfastening preventing structure, which comprises: a fix bolt including a head designed to be fitted to a fastener tool and a body integrally formed with the head, the body having a threaded portion on a circumferential surface thereof and a press fit portion formed at one end thereof; and a fix member having a press fit hole into which the press fit portion is to be press-fitted.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view of the principal part of a conventional fix bolt in a fastened state;

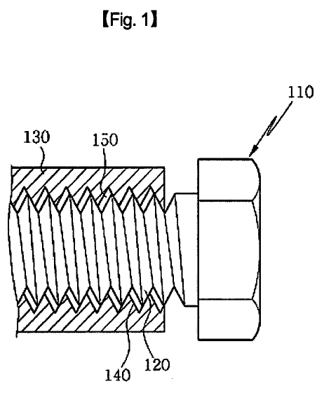

FIG. 2 is a view of a conventional fix bolt having an unfastening preventing structure;.

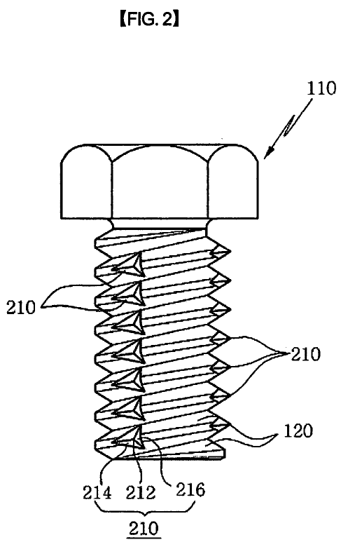

FIG. 3 is a sectional view of a principal part of a fix bolt-unfastening preventing structure according to a first embodiment of the present invention;

FIG. 4 is a sectional view of a part of an oil pressure control valve of an automobile steering system to which the fix bolt according to the first embodiment of the present invention is being fastened;

FIG. 5 is a sectional view of a principal part of a fix bolt-unfastening preventing structure according to a second embodiment of the present invention; and

FIG. 6 is a sectional view of a tilt column of an automobile steering system to which the fix bolt according to the second embodiment of the present invention is being fastened.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

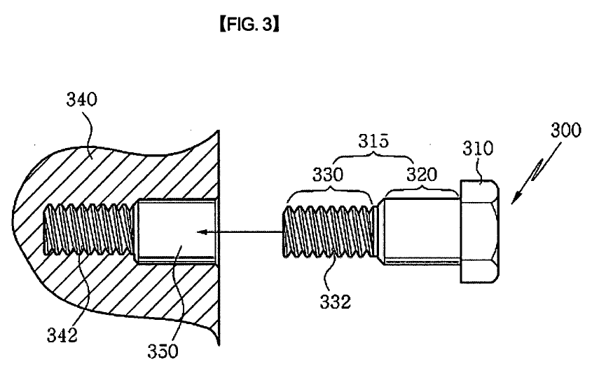

FIG. 3 is a sectional view of a principal part of a fix bolt-unfastening preventing structure according to a first embodiment of the present invention. As shown in the drawing, a fix bolt 300 according to the present invention includes a head 310 designed to be fitted to a fastener tool, and a body 315 which is integrally formed with the head 310 at one surface of the head 310 and is comprised of a press-fit portion 320 and a threaded portion 330.

The head 310, which is fitted to the fastener tool when fastened to a fix member 340, includes various types, such as a countersunk head, a rounded head, a hexagon head, etc., and may have a recess where the fastener tool is to be fitted.

The body 315 includes the press-fit portion 320 press-fitted to the fix member 340 and the threaded portion 330 threaded engaged with the fix member 330.

The press-fit portion 320 is disposed at an end of one side of the body 315 and is integrally formed with the head 310 at the center of the one side of the head 310. The press-fit portion 320 is designed to be press-fitted into the fix member 340 by a force in an axis direction generated when the fix bolt 300 is threaded engaged with the fix member 340 and may have various shapes such as a cylindrical shape, polygonal shape, etc., but the cylindrical shape is preferable.

It is also preferable that the press-fit portion 320 is formed to have a size greater than that of a press fit hole 350 by a predetermined size so that it is press-fitted into the press fit hole 350 formed in the fix member 340 as described below.

The threaded portion 330 is formed at an end of the press-fit portion 320 and is a portion to be in direct contact with the fix member 340. Here, the threaded portion 330 is manufactured into a male screw thread to be threaded engaged with the fix member 340, and has a size smaller than that of the press-fit portion 320 so as not to rub against the press fit hole 350.

In other words, the press-fit portion 320 of the fix bolt 300 is formed to have a size greater than that of the press fit hole 350 by a predetermined size, and the threaded portion 330 is formed to have a size smaller than that of the press fit hole 350, so that the threaded portion 330 passes through the press fit hole 350. As a result, the conventional problem that the male screw thread is injured when threaded engaged can be overcome.

Here, the fix member 340, to which the fix bolt 300 is to be fastened, has the press fit hole 350 formed inwardly from an end surface thereof, and a female screw thread 342 formed at a back end of the press fit hole 350, with which the male screw thread 332 is to be threaded engaged.

It is also preferable that the length of the press fit portion 320 of the fix bolt 300 and the length of the press fit hole 350 of the fix member 340 are defined according to magnitudes of vibrations.

In addition, the fix bolt 300 having the press-fit portion 320 of the present invention may be used for any machinery which has bolted portions and the press fit hole 350 into which the press-fit portion 320 can be press-fitted.

For example, most components of an automobile steering system are fastened by fix bolts when assembled. Thus, by forming the press fit holes 350 respectively at connection portions to which the fix bolts are to be fastened, and then bolting and press-fitting the fix bolts 300, each having the press-fit portion 320, respectively, to the connection portions, each fix bolt 300 is tightly fastened by a press fit load generated when each press-fit portion 320 is press-fitted into each press fit hole 350, thereby overcoming the conventional problem in that the fix bolts 300 become loose and unfastened by vibrations generated while traveling.

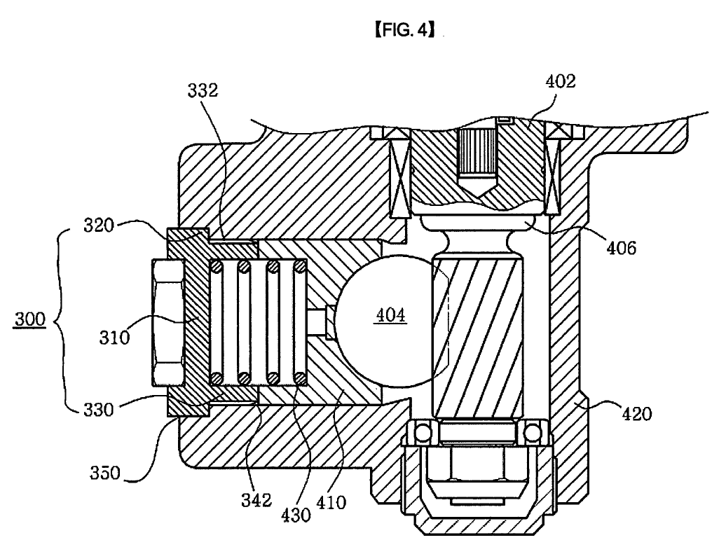

FIG. 4 is a sectional view of a part of an oil pressure control valve of an automobile steering system in which the fix bolt according to the first embodiment of the present invention is being fastened. As shown in the drawing, the oil pressure control valve includes a rack bar 404 which receives torque from an input shaft 402, a support yoke 410 disposed at a back surface of the rack bar 404, a pinion housing 420 having a press fit hole 350 formed therein, and the fix bolt 300 having the press fit portion and pressing upon the support yoke 410.

The support yoke 410 is a component for reducing a gap between the rack bar 404 and the pinion shaft 406 so as to smoothly transfer motive power. In addition, a spring 430 may be disposed at the back of the support yoke 410 so as to push the support yoke 410 with predetermined pressure, thereby compensating for the gap between the rack bar 404 and the pinion shaft 406, and thus allowing the rack bar 404 and the pinion shaft 406 to come in close contact with each other in order to efficiently transfer the motive power.

The fix bolt 300 supports the spring 430 to press the support yoke 410. The fix bolt 300 may have, in the head 310 thereof, a recess in which a wrench can be fitted, so that the fix bolt 300 can be tightened by using the wrench in order to adjust the tension of the spring 430 when the fix bolt 300 is fastened and when a gap between the rack bar 404 and the pinion shaft 406 arises. The fix bolt 300 has, at an end thereof, the press fit portion 320 which is press-fitted into the press fit hole 350 formed in the pinion housing 420. There is disposed, at a front end of the press-fit portion 320, the male screw thread 332 formed on a circumferential surface of the body, which is threaded engaged with the female screw thread 342 of the pinion housing 420.

In other words, the press fit holes 350 are formed in the pinion housing 420, and then the fix bolts 300 having the press-fit portion 320 are inserted into the press fit hole 350 and are rotated when the support yoke 410 to attenuate a vibration of the rack bar 404 is assembled to the pinion housing 420. Here, the unfastening of the fix bolt 300 due to vibration generated when traveling can be prevented by press fit loads generated when the press-fit portions 320 are press-fitted into the press fit holes 350.

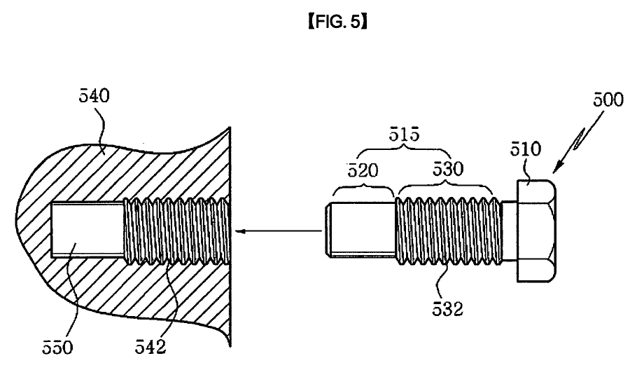

FIG. 5 is a sectional view of a principal part of a fix bolt-unfastening preventing structure according to a second embodiment of the present invention. As shown in the drawing, a fix bolt 500 according to the second embodiment of the present invention includes a head 510 designed to be fitted to a fastener tool, and a body 515 formed at an end of the head 510.

The body 515 is comprised of a threaded portion 530 integrally formed with the head 510 and a press fit portion 520 disposed at a front end of the threaded portion 530.

An end of the threaded portion 530 is connected to an end of the center of one surface of the head 510 so as to be integrally formed with the head 510. The threaded portion 530 is manufactured as a male screw thread 532 formed on a circumferential surface of the body 515 so that the threaded portion 530 is directly fastened to a fix member 540.

The press fit portion 520 is disposed at another end of the threaded portion 530 and is integrally formed with the threaded portion 530, so that it is press-fitted into the fix member 540. Thus, the press fit portion 520 may be various shapes, such as a cylindrical shape and a polygonal shape, but is preferably the cylindrical shape.

Preferably, the press fit portion according to the second embodiment of the present invention has a size as long as it does not damage a female screw thread 542 when fastened to the fix member 540.

The fix member 540 has, at an end thereof, a female screw thread 542 with which the fix bolt 500 is threaded engaged, and at a back end of the female screw thread 542, a press fit hole 550 into which the press fit portion 520 of the fix bolt 500 is press-fitted.

In addition, the fix bolt 500 having the press fit portion 520 of the present invention may be used for any machinery which has bolted portions and the press fit hole 550 into which the press-fit portion 520 can be press-fitted.

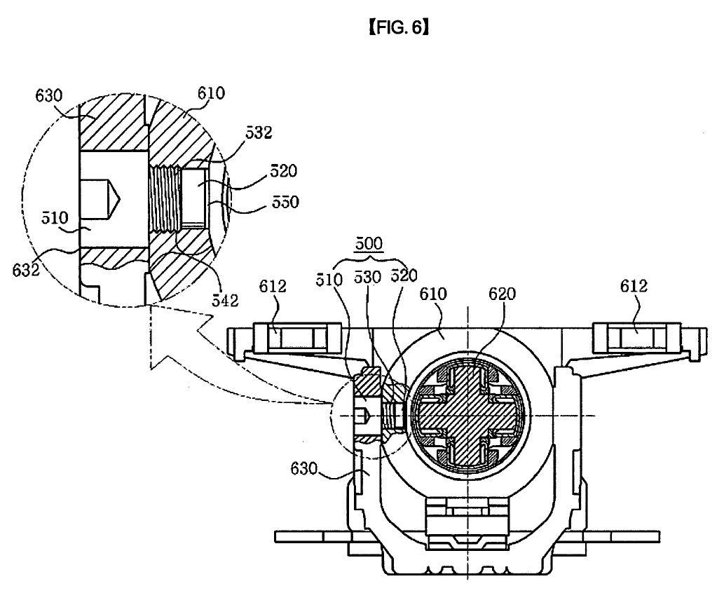

FIG. 6 is a sectional view of a tilt column of an automobile steering system to which the fix bolt according to the second embodiment of the present invention is being fastened. As shown in the drawing, the tilt column includes a column housing 610 which is secured to a car body by means of a capsule 612 disposed on an surface of an upper side thereof, a tilt bracket 630 rotatably connected to the column housing 610, and the fix bolt 500 connecting the tilt bracket 630 to the column housing 610.

The column housing 610 has connection holes, each having a press fit hole 550 at both sides of a circumferential surface, so that the tilt bracket 630 can be connected thereto by the fix bolt 500. Here, each of the connection holes has a female screw thread 542 with which the male screw thread 532 of the fix bolt 500 is threaded engaged, and a press fit hole 550 at an end of the female screw thread 542. The press fit hole 550, into which the press fit portion 520 of the fix bolt 500 is press-fitted, has a diameter smaller than that of the female screw thread 542 so that the press fit portion 520 of the fix bolt 500 can be press-fitted thereinto. Here, it is preferable that the connection holes are formed to correspond to the center of an axis of a universal joint disposed within the column housing 610.

The tilt bracket 630 has insertion holes 632 into which the fix bolts 500 are respectively inserted in a manner that their head do not protrude the outside of the insertion holes 632, so that the tilt bracket 630 is connected at both sides of a circumferential surface of the column housing 610. Meanwhile, the center of an axis of the fix bolt 500, like the column housing 610, corresponds to the center of the axis of the universal joint, so that the tilt bracket 630 and a steering shaft are rotated together on a concentric circle, thereby enabling a tilt operation.

The above mentioned fix bolt 500 according to the second embodiment of the present invention is inserted into each insertion hole 632 and is rotated by fitting a fastener tool at the head of the fix bolt and then rotating the fastener tool, whereby the male screw thread of the treaded portion 530 formed at the back end of the head 510 to be integrally formed with the head 510 is threaded engaged with each of the female screw thread 542 formed in each of the connection holes of the column housing 610. Here, the press fit portion 520 formed at the front end of the threaded portion 530 passes through the connection hole and the female screw thread 542, and then is press-fitted into the press fit hole 550 disposed at the end of the female screw thread 542, so that unfastening of the fix bolt 500 due to vibration generated when traveling can be prevented by a press fit load.

According to the present invention as described above, there is an advantage that in order to prevent unfastening of the fix bolt which is used for connection of various components, the fix bolt is threaded engaged with the fix member while the press fit portion formed at the end of-the male screw thread of the fix bolt is press-fitted into the press fit hole formed at an end of the fix member, which enables the reduction of parts and cost and the prevention of unfastening of the fix bolt.

It is another advantage of the present invention that the press fit portion is formed at the threaded portion of the fix bolt, thereby reducing the working time needed for precision machining and increasing productivity.

Although an exemplary embodiment of the present invention has been described for illustrative purposes, those skilled in the art will appreciate that various modifications, additions and substitutions are possible, without departing from the scope and spirit of the invention as disclosed in the accompanying claims. Accordingly, the scope of the invention is not to be limited by the above embodiments but by the claims and the equivalents thereof.

What is claimed is:

1. A fix bolt-unfastening preventing structure, comprising:
a fix bolt including a head designed to be fitted to a fastener tool, and a body integrally formed with the head, the body having a threaded portion on a circumferential surface thereof and a press fit portion formed at one end thereof; and
a fix member having a press fit hole into which the press fit portion is to be press-fitted.

2. The fix bolt-unfastening preventing structure as claimed in claim 1, wherein the size of the press fit portion is greater than that of the press fit hole.
